(19) United States
(12) Patent Application Publication
(10) Pub. No.: US 2022/0032546 A1
(43) Pub. Date: Feb. 3, 2022

(54) SYSTEMS AND METHODS FOR BLOCKAGE REMOVAL IN THREE-DIMENSIONAL PRINTERS

(71) Applicant: MARKFORGED, INC., Watertown, MA (US)

(72) Inventors: Bennett McClelland Wilson, Jamaica Plain, MA (US); Joseph Roy-Mayhew, Watertown, MA (US); Christopher Hoffman, Watertown, MA (US); Antoni S. Gozdz, Acton, MA (US)

(21) Appl. No.: 16/941,788

(22) Filed: Jul. 29, 2020

(51) Int. Cl. B29C 64/386; B29C 64/321; B29C 64/35; B29C 64/209; B33Y 10/00; B33Y 50/00; B33Y 30/00

(52) U.S. Cl. CPC B29C 64/386; B29C 64/321; B29C 64/35; B33Y 30/00; B33Y 10/00; B33Y 50/00; B29C 64/209

(57) ABSTRACT

Methods of printing using three dimensional printers are disclosed. The method includes feeding a printable material through a linear feed mechanism to a print head, detecting the printable material is jammed in the three-dimensional printer, and operating, in response to detecting that the printable material is jammed, the three-dimensional printer in a jam clearing mode. The jam clearing mode includes advancing a drive component of the linear feed mechanism, retracting the drive component of the linear feed mechanism, and repeating the advancing and retracting of the drive component of the linear feed mechanism. Three-dimensional printing systems are also disclosed. A three-dimensional printing system includes a print head, a linear feed mechanism operatively coupled to the print head, and a controller operatively coupled to the three-dimensional printing system.

### FIELD OF TECHNOLOGY

Aspects and embodiments disclosed herein are directed to three-dimensional printers and methods of operating said printers.

### BACKGROUND

Additive manufacturing, or three-dimensional (3D) printing, includes various methods for producing 3D parts. Typically, 3D printing refers to the direct fabrication of physical products from a 3D computer model by a layered manufacturing process. In 3D printing, three dimensional articles may be fabricated from print material in the form of plastic, metal, ceramic, or combination materials. In at least one example of a metal-based 3D printing system, a spherized metal powder is embedded in a binder matrix of a filament that can be used as the feedstock material for a 3D printer, such as that described in US Patent Application publication US 2019/0270254, the disclosure of which is herein incorporated by reference in its entirety for all purposes. Metals that can be printed include, but are not limited to, various types of steels (e.g., stainless, tool steel), copper, and alloys. The part is printed using the metal containing filament by applying successive layers of the filament to a build platen. The binder matrix of the deposited filament is removed from the printed part to leave behind the part formed of loosely bound metal particles. The part including the loosely bound metal particles is sintered using a furnace to allow the metal particles to solidify into a solid part.

### SUMMARY

In accordance with one aspect, there is provided a method of printing using a three-dimensional printer. The method may comprise feeding a printable material through a linear feed mechanism to a print head. The method may further comprise detecting the printable material is jammed in the three-dimensional printer. The method may additionally comprise operating, in response to detecting that the printable material is jammed, the three-dimensional printer in a jam clearing mode. The jam clearing mode may comprise advancing a drive component of the linear feed mechanism, retracting the drive component of the linear feed mechanism, and repeating the advancing and retracting of the drive component of the linear feed mechanism. In the methods, one advancing step and one retracting step may comprise one cycle of the jam clearing mode.

In some embodiments, detecting the jammed printable material includes detecting a force applied to the printable material by the drive component of the linear feed mechanism. For example, detecting the change in force includes detecting a change in the motion of an idle component of the linear feed mechanism.

In some embodiments, advancing of the drive component of the linear feed mechanism includes advancing a drive wheel of the linear feed mechanism. In further embodiments, retracting of the drive component of the linear feed mechanism includes retracting the drive wheel of the linear feed mechanism.

In some embodiments, the jam clearing mode operates at a repetition rate of at least 1 Hz. In some embodiments, the jam clearing mode is operated up to 256 cycles.

In further embodiments, the method comprises returning the three-dimensional printer to the printing mode upon clearing of the jammed printable material.

In further embodiments, the method comprises wiping the print head. The wiping of the print head occurs prior to the advancing of the drive component of the linear feed mechanism.

In further embodiments, the method comprises detecting an uncleared jammed printable material after the advancing and retracting of the drive component of the linear feed mechanism.

In further embodiments, the method comprises alerting a user or operator of the uncleared jammed printable material.

In accordance with another aspect, there is provided a three-dimensional printing system. The system may comprise a print head, a linear feed mechanism operatively coupled to the print head to advance a printing material into the print head, and a controller operatively coupled to the three-dimensional printing system. The linear feed mechanism may comprise an idle component and a drive component, with the drive component configured to advance the printing material into the print head. The controller may be configured to monitor a printing mode of the three-dimensional printing system, identify a jammed printing material in the three-dimensional printing system, and operate the three-dimensional printer in a jam clearing mode in response to identifying the jam. The jam clearing mode may include advancing the drive component of the linear feed mechanism, retracting the drive component of the linear feed mechanism, and repeating the advancing and retracting of the drive component of the linear feed mechanism.

In some embodiments, the drive component includes a drive wheel and the idle component includes an idler wheel configured to apply a horizontal force to compress the printing material against the drive wheel.

In further embodiments, the controller is configured to identify the jammed printing material by sensing a force applied to the printing material by the drive wheel of the linear feed mechanism. In sensing the force, the controller is further configured to detect a change in the motion of the idler wheel of the linear feed mechanism of the three-dimensional printer. In some embodiments, if the force applied to the printing material by the drive wheel exceeds a predetermined threshold, the controller is configured to operate the three-dimensional printer in the jam clearing mode.

In further embodiments, the system includes a wiping station comprising a wiper positioned in proximity to the print head. The wiper may be a metallic brush, such as a brass brush. In further embodiments, the controller is configured to direct the print head to the wiping station before operating the three-dimensional printer in the jam clearing mode.

In further embodiments, the controller is configured to detect a jammed printing material that has not been cleared after completion of the jam clearing mode. In further embodiments, the controller is configured to alert a user or operator of the jammed printing material that has not been cleared.

### BRIEF DESCRIPTION OF THE DRAWINGS

The accompanying drawings are not drawn to scale. In the drawings, each identical or nearly identical component that is illustrated in the various figures is represented by a like numeral. For purposes of clarity, not every component may be labeled in every drawing. In the drawings:

FIGS. 1A-1C illustrates a cross-section schematic of the formation of a jam in an aperture. FIG. lA illustrates a clear aperture. FIG. 1B illustrates an aperture with a reduction in diameter due to a buildup of particles. FIG. 1C illustrates a jammed aperture;

FIG. 2 illustrates a three-dimensional printer comprising a linear feed mechanism, according to one or more embodiments;

FIG. 3 illustrates the reduction in jam events in a three-dimensional printer that includes a jam clearing mode, according to one or more embodiments;

FIG. 4 illustrates a method of operating a three-dimensional printer, according to one or more embodiments; and

FIG. 5 illustrates a method of operating a three-dimensional printer, according to one or more embodiments.

### DETAILED DESCRIPTION

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. Also, the phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims.

References to “or” may be construed as inclusive so that any terms described using “or” may indicate any of a single, more than one, and all of the described terms.

Aspects and embodiments described herein relate to the formation and clearing of blockages or clogs, referred to herein as “jams,” in the print heads of three-dimensional printers. Jams located in a materials feed path of three-dimensional printers and systems, the mechanisms by which these jams form, and methods of clearing these to recover printers and systems from interruptions caused therefrom, is a problem that has yet to be fully considered in the additive manufacturing industry. Jams occur when printing material being moved through the print head becomes lodged within the material pathway that connects the printing material feed system to the outlet or exit aperture of the print head, preventing proper delivery of printing material to the build platen. Without wishing to be bound by any particular theory, jams as described herein may be caused by the design of the three-dimensional printer, the physical and chemical characteristics of the printing material, or a combination of both.

With respect to the design of the three-dimensional printer, jams may occur if a material feed mechanism of the three-dimensional printer is limited in the force it can apply to the printing material. In regard to the printing materials, with the use of printing materials comprising spherized metal particles embedded in a binder matrix, one or both of the spherized metal particles and binder matrix may be part of the underlying cause of a jam. For example, a printing material comprising a particulate system with effective particle diameters within a factor of 50 of the print head diameter may contribute to jams in the three-dimensional printer. In some cases, jams may be caused by stochastic metal particles from the printing material that, during flow, form a bridge within the print head and cause a constriction to form. Jams may further be caused by a localized increase in the viscosity of the melted printing material binder due to a local increase in the metal particle concentration in the printing material, preventing flow. Jams may be additionally caused by agglomeration of compromised printing material binder, for example, printing material binder that has been thermally degraded that may clump or bind together to form a larger obstruction.

In some cases, the combination of printer component geometry and printing material properties may contribute to the formation of jams. For example, a printing material having an inconsistent material blend, when acted on by the feed mechanism of the printer, can have one of its components pushed out of the print head earlier in time, changing the local blend that is printed. As a specific example, for a printing material including metal particles in a wax binder, the wax can be selectively pushed out due to viscosity and pressure, thus leading to dry spots, that is, regions devoid of particles, in the printed part. The geometry of the print head may exacerbate this problem. With reference to the wax example, a print head having an interior transition geometry with a square transition between diameters performs poorly, i.e., jams more frequently, relative to a print head having an interior transition geometry that is angled.

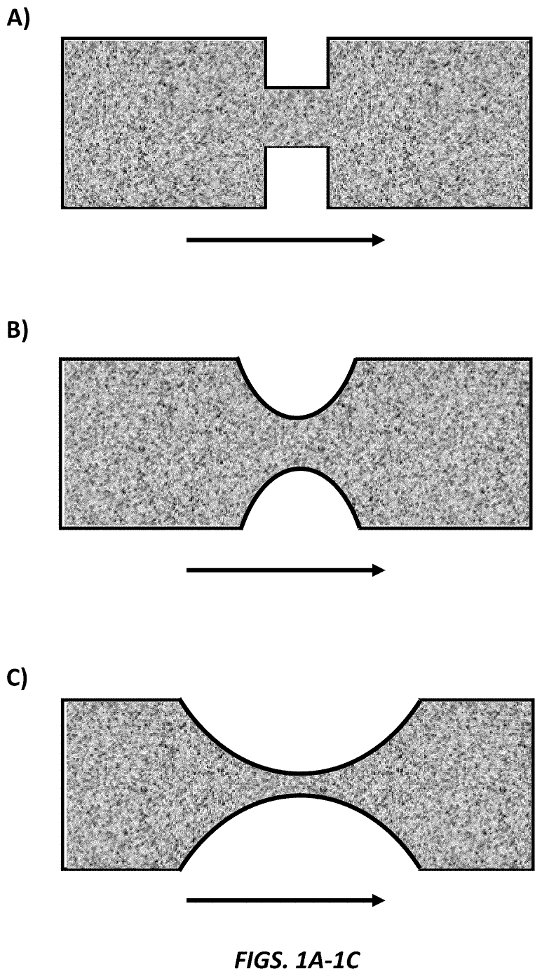

An example of a jam forming in an aperture having a square transition is illustrated in FIGS. 1A-1C. In FIGS. 1A-1C, the flow of printing material through the print head is from left to right as indicated by the arrow. In FIG. 1A, particles from the printing material can flow unimpeded through the aperture. In FIG. 1B, a portion of the particles experience stochastic motion and have begun to build up on either side of the aperture, decreasing the aperture diameter. In FIG. 1C, the particles have continued to build up on either side of the aperture and have decreased its diameter to the point where particles can no longer pass through, thus causing a jam.

Conventionally, attempts to reduce the frequency of jams were made by implementing selective changes to the design of the three-dimensional printer and/or in the composition of the printing materials. Such changes for both the printer and the materials have been found to have notable drawbacks and limitations. For example, a relative rate of jams could be reduced by using a material or feed mechanism that applies very high pushing force. Changing to this type of feed mechanism can alter the properties of the printing material and increase the cost of the three-dimensional printer. The frequency of jams can also be reduced by increasing the diameter of the print head. While this allows for the use of printing materials formed from larger particle sizes, the resolution of the printer is reduced and thus it is more difficult to print certain types of parts. In some cases, the frequency of jams can be reduced by using printing materials that include very small particle sizes. These are expensive materials and thus may be unsuitable for high volume additive manufacturing processes. The frequency of jams may be additionally reduced by using a printing material that includes a lower loading of binder or filler material. Printing materials using lower loading of binder or filler materials are typically undesirable as the printed part will have more shrinkage, which increases the stress in the final part, resulting in a poorer part quality. It is an object of this disclosure to provide for systems and methods than circumvent the need to use any of the aforementioned ways of reducing jams in a three-dimensional printer.

Previous means for clearing jammed printers prior to this disclosure have shown some success, but these successes were revealed to be inconsistent, have generally required manual intervention to locate and clear the jam, and have introduced costly mid-print delays. In some cases, a first means to clear a jammed printer involves unloading the printing material and attempting to reload said material back into the three-dimensional printer. The unloading and reloading of printing material is generally directed to clearing the print head; if the print head can be unloaded down to its exit aperture, reloading the printer with the printing material will typically allow for the resumption of printing. Should the unloading and reloading of the printing material not be successful, the print head may have a blockage or an obstruction in a different section of the print head, such as in a tube connected to the print head. For example, there may be agglomerated wax, binder, or other debris in the tube leading to the print head. In this instance, the tube leading to the print head needs to be replaced. Should replacing the tube leading to the print head not allow for the resumption of printing, the print head may have a blockage or an obstruction at or near its exit aperture, which requires replacement with a new exit aperture. In circumstances where replacing the tube leading to the print head and replacing the exit aperture does not allow for the resumption of printing, the jam may be located in the heated tube directly ahead of the exit aperture known as the heatbreak. Clearing a heatbreak jam requires the use of a purge rod to apply pressure to jammed material in the heatbreak and force said material out of the print head. The heatbreak may also be cleaned manually with a brush to remove any jammed material from its tube. In any of these instances, these manual repair steps are both time- and labor-intensive, and thus are not desired by operators or customers. In some cases, an operator or customer may either not realize there is an issue with the printer or may simply ignore an issue with the printer, thus putting the three-dimensional printer at risk for further damage with continued use. It is an object of this disclosure to provide for systems and methods than circumvent the need to use the aforementioned means of clearing jams in a three-dimensional printer.

Jams, if not removed, may damage the three-dimensional printer or the part being printed and decrease printer throughput. For example, jammed printing material can result in lost time during a printing process, both in printer downtime and operator downtime. With respect to operator downtime, a jammed three-dimensional printer that cannot be automatically cleared may require an operator to manually clear or repair as described herein, overall decreasing printer throughput. Jams also can increase the cost of operating the three-dimensional printer. Jammed print heads can result in the loss of materials, thus requiring the use of a greater amount of material to complete the printing of a part. In some cases, a jam that is not recoverable may result in the loss of a partially printed part. For example, when the three-dimensional printer is jammed and waiting for an operator to clear the jam, the part being printed is sitting on the printer's build platen, which may be heated. Overheating the partially printed part may induce the formation of defects into the part, rendering the part unacceptable for its intended use.

In some embodiments, a printing material as disclosed herein may include any type of material used for additive manufacturing including, but not limited to, fibers, filaments, rods, pellets, or powders. The printing material may include spherized metal particles bound into a polymer matrix. Metals that can be printed include, but are not limited to, various types of steels (e.g., stainless, tool steel, e.g., 17-4 tool steel), copper, and alloys. Binders that are included in printing materials include, but are not limited to, waxes or other meltable polymeric materials. For example, soluble and pyrolyzable binder combinations include polyethylene glycol (PEG) and polymethyl methacrylate (PMMA) (optionally including stearic acid), waxes (e.g., carnauba, bees wax, paraffin) mixed with steatite and/or polyethylene (PE), PEG, polyvinylbutyral (PVB), and stearic acid. Some pyrolyzable second stage binders include, but not limited to, polyolefin resins, polypropylene (PP), high-density polyethylene (HDPE), linear low-density polyethylene (LLDPE), and polyoxymethylene copolymer (POM). In some cases, the printing materials may be solid at ambient temperature and can either soften or liquefy when heated to allow passage through the print head of the three-dimensional printer. The printing materials may be delivered to the print head using any number of different mechanisms that will depend, at least in part, on the physical form of the printing material. For example, the printing material may be delivered to the print head by being driven, fed from a hopper, or delivered from a spool or coil. As a non-limiting example, if the printing materials is a rod, the rod may be directly driven into the print head using a screw-type or other similar mechanism. As another non-limiting example, if the printing material is a filament wound on a spool, a feed mechanism may include a series of rollers to direct the printing material to the print head.

In accordance with one or more embodiments, a three-dimensional printing system is disclosed. The system may include a print head positioned proximate a build platen, a linear feed mechanism operatively coupled to the print head, and a controller operatively coupled to the three-dimensional printer configured to monitor a printing mode of the three-dimensional printing system, identify a jammed printing material in the three-dimensional printing system, and operate the three-dimensional printer in a jam clearing mode in response to identifying the jammed printing material. The linear feed mechanism of the three-dimensional printer may include an idle component and a drive component with the drive component configured to advance the printing material into the print head. The jam clearing mode may comprise advancing the drive component of the linear feed mechanism, retracting the drive component of the linear feed mechanism, and repeating the advancing and retracting of the drive component of the linear feed mechanism.

In some embodiments, the idle component may include an idler wheel and the drive component may include a drive wheel. The idler wheel is undriven and can freely rotate about its rotational axis. The idler wheel may be operatively coupled to a pivot that permits horizontal motion of the idler wheel in the plane of rotation. The pivot may be connected to a spring or the like that allows the idler wheel to be held in position. The drive wheel may be operatively coupled to a source of motion, such as an electric motor. The drive wheel may further include surface structures that can provide for a secure hold on the printing material, such as teeth or another similar surface structure. The drive wheel and idler wheel may be positioned parallel to each other such that the printing material can be held between the wheels. In this configuration, the printing material to be fed to the print head is positioned between the idler wheel and drive wheel. The spring pivot of the idler wheel provides for a compressive force that holds the printing material against any structural features, such as teeth, of the drive wheel. As the drive wheel is actuated by a motor, the printing material held between the wheels is guided to the print head. The idler wheel may further include structural features, such as stops, that limit its horizontal motion. For example, the idler wheel pivot may include a maximum position stop and a minimum position stop that defines the maximum and minimum gap between the idler wheel and the drive wheel.

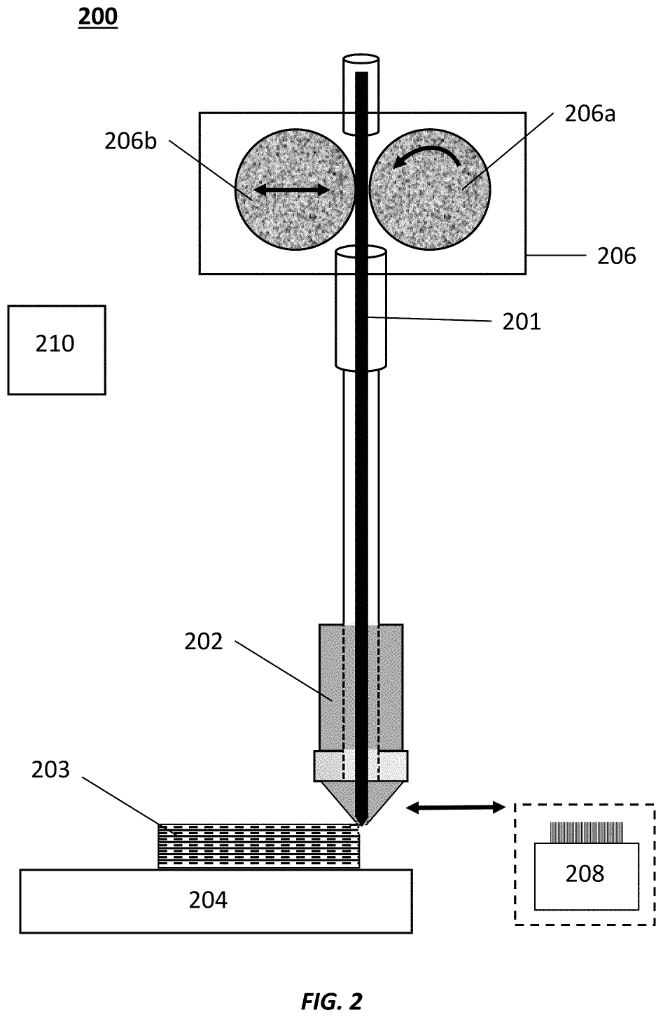

An embodiment of a three-dimensional printer is illustrated in FIG. 2. With reference to FIG. 2, three-dimensional printer 200 includes print head 202 positioned proximate build platen 204. Printing material 201 is fed into the print head 202 by linear feed mechanism 206 (outlined in the black line box) to form a part 203. Linear feed mechanism 206 includes drive wheel 206a and idler wheel 206b. The curved arrow on drive wheel 106a indicates the rotation direction that feeds printing material 201 into print head 202. The double ended arrow on idler wheel 206b indicates the allowed horizontal motion of the idler wheel 206b that compresses the printing material 201 into drive wheel 206a such that it can be fed into the print head 202. Further shown in FIG. 2 is controller 210 that configured to operate the three-dimensional printer 200 (i.e., the linear feed mechanism 206) in a printing mode to provide the printing material 201 to the print head 202 and deposit the printing material 201 in a layered fashion on the build platen 204. The controller 210 is further configured to operate the three-dimensional printer 200 in a jam clearing mode responsive to detecting a jammed printing material at some location in the three-dimensional printer 200. Additionally, shown in FIG. 2 in the dashed line box is a wiping station 108, described in greater detail below.

While operating in the printing mode, the controller 210 monitors the printer 200 to identify a jammed printing material. A jam as described herein may be detected by the controller 210 sensing the force applied to the printing material 201 by the drive wheel 206a of the linear feed mechanism 206. Without wishing to be bound by any particular theory, as a printing material 101 becomes jammed, the motor of the drive wheel 206a has to provide more rotational force, i.e., torque, to continue to feed the printing material 201 to the print head 202. If the back pressure generated by the printing material 201 becomes too high, the drive wheel 206a can no longer feed the printing material 201 to the print head 202. Because the drive wheel 206a and idler wheel 206b move together to feed the printing material 201 to the print head 202, when the drive wheel 206a stops rotating, the idler wheel 206b also stops rotating. Thus, in some embodiments, in sensing the force, the controller 210 may be further configured to detect a change in the motion of the idler wheel 206b of the linear feed mechanism 106 of the three-dimensional printer 200. For example, the idler wheel 206b may include a sensor (not indicated) that sends a signal to the controller 210 to indicate that its motion has stopped, thus indicating that the printing material 201 is jammed.

In some embodiments, when the controller receives indication that the printing material is jammed, the controller may operate the three-dimensional printer in a jam clearing mode. The jam clearing mode is configured to, by mechanically agitating the printing material, break up any obstructions, such as agglomerates of binder or stochastic metal particles, that have formed in the print head or another location along the material pathway of the three-dimensional printer. Without wishing to be bound by any particular theory, the repeated cycling, e.g., the repeated advancing-and-retracting, of the heated printing material may alter the physical structure or state of the jammed printing material. For example, the repeated cycling may induce mixing of the printing material, promoting the breakup of any agglomerated material and/or increasing dispersibility of the printing material. In some cases, the repeated cycling may disrupt the alignment of the printing materials polymer chains and/or filler material, thus allowing it to flow. The jam clearing mode may comprise advancing the drive component of the linear feed mechanism and retracting the drive component of the linear feed mechanism. The advancing and retracting of the drive component, i.e., the drive wheel, advances and retracts the printing material to break up any obstructions. Each advance-and-retract of the drive component may be considered as one cycle of the jam clearing mode. In some embodiments, the jam clearing mode operates at a repetition rate of at least 1 Hz. For example, the jam clearing mode may perform 50 cycles in 40 seconds, giving a repetition rate of 1.25 Hz. This is exemplary, and other repetition rates are within the scope of this disclosure.

The advancing and retracting of the drive component may be repeated for a fixed duration of time and/or for a fixed number of cycles. For example, in some embodiments, the jam clearing mode may be operated up to 256 cycles, e.g., from 1 cycle to 25 cycles, from 5 cycles to 50 cycles, from 25 cycles to 100 cycles, from 50 cycles to 125 cycles, from 75 cycles to 150 cycles, from 100 cycles to 175 cycles, from 125 cycles to 200 cycles, from 150 cycles to 225 cycles, or from 175 cycles to 256 cycles, e.g., 1 cycle, 2 cycles, 3 cycles, 4 cycles, 5 cycles, 6 cycles, 7 cycles, 8 cycles, 9 cycles, 10 cycles, 20 cycles, 25 cycles, 30 cycles, 35 cycles, 40 cycles, 45 cycles, 50 cycles, 55 cycles, 60 cycles, 65 cycles, 70 cycles, 75 cycles, 80 cycles, 85 cycles, 90 cycles, 95 cycles, 100 cycles, 110 cycles, 120 cycles, 130 cycles, 140 cycles, 150 cycles, 160 cycles, 170 cycles, 180 cycles, 190 cycles, 200 cycles, 210 cycles, 220 cycles, 230 cycles, 240 cycles, 250 cycles, or 256 cycles. In some embodiments, the jam clearing mode may be operated for up to 180 seconds, e.g., from 1 second to 30 seconds, from 15 seconds to 60 seconds, from 45 seconds to 90 seconds, from 60 seconds to 100 seconds, from 75 seconds to 120 seconds, from 100 seconds to 150 seconds, or from 120 seconds to 180 seconds, e.g., 1 second, 2 seconds, 3 seconds, 4 seconds, 5 seconds, 6 seconds, 7 seconds, 8 seconds, 9 seconds, 10 seconds, 20 seconds, 30 seconds, 40 seconds, 50 seconds, 60 seconds, 70 seconds, 80 seconds, 90 seconds, 100 seconds, 110 seconds, 120 seconds, 130 seconds, 140 seconds, 150 seconds, 160 seconds, 170 seconds, or 180 seconds. As a non-limiting example, a jam clearing mode of a three-dimensional printer as described herein may operate for about 10 seconds, providing for about 40-50 cycles of the jam clearing mode. In some embodiments, the jam clearing mode may operate for any length of time and/or number of cycles until the jammed printing material is cleared. One of skill in the art can appreciate that any number of cycles, jam clearing mode duration, or other variables may be adjusted based on the printing material composition, printing characteristics, or other physical qualities of the printing material.

In some embodiments, the jam clearing mode may include adjusting a temperature of the print head during the jam recovery mode. For example, the jam clearing mode may include increasing the temperature of print head prior to and/or during the advance-and retract cycle. Alternatively, or in addition, the jam clearing mode may include decreasing the temperature of print head prior to and/or during the advance-and retract cycle. One of skill in the art can appreciate that the adjustment of the print head temperature prior to and/or during operation of the jam clearing mode may affect the viscosity of the printing material, and the adjustments to the temperature may be based on the printing material composition, printing characteristics, or other physical qualities of the printing material.

In some embodiments, the forces applied to a jammed printing material by the linear feed mechanism during the jam clearing mode may be dependent on the material the printing material is fabricated from. In some aspects, each advance-and-retract cycle of the jam clearing mode advances and retracts the drive component of the linear feed mechanism the same distance at a fixed repetition rate; thus, each cycle may advance and retract the printing material by about the same distance. In some aspects, each advance-and-retract cycle of the jam clearing mode advances the drive component of the linear feed mechanism a greater distance than it retracts. In some aspects, each advance-and-retract cycle of the jam clearing mode retracts the drive component of the linear feed mechanism a greater distance than it advances. For example, each cycle of the jam clearing mode may advance and/or retract the printing material up to about 10 mm, e.g., about 0.1 mm, about 0.2 mm, about 0.3 mm, about 0.4 mm, about 0.5 mm, about 0.6 mm, about 0.7 mm, about 0.8 mm, about 0.9 mm, about 1 mm, about 2 mm, about 3 mm, about 4 mm, about 5 mm, about 6 mm, about 7 mm, about 8 mm, about 9 mm, or about 10 mm. The amount of the printing material moved during one cycle of the jam clearing mode may be greater during the advance portion. Alternatively, the amount of the printing material moved during one cycle of the jam clearing mode may be greater during the retract portion, and all ratios of the distance between the advance and retract portions of the jam clearing mode described herein are envisioned by this disclosure. In some aspects, a ratio of an advance motion to a retract motion is about 50:50. In some aspects, an advance motion is about 25%, about 30%, about 35%, about 40%, about 45%, about 55%, about 60%, about 65%, about 70%, or about 75% that of a retract motion. As the different printing material compositions have differing responses to the advance-and-retract cycle of the jam clearing mode, the applied force to the jammed printing material, and thus an efficiency of the jam clearing mode, may depend on the printing material composition. Should the jammed printing material not move during either the advance or retract portion of a jam clearing mode cycle, an end user or operator may be notified after completion of the jam clearing mode. One of skill in the art can appreciate that the parameters of the jam clearing mode may be adjusted to account for variations in the printing material composition.

In some embodiments, the jam clearing mode may allow for a reduction in the number of jams in the printing material that require the three-dimensional printer to be removed from service for maintenance. For example, three-dimensional printers that do not have a jam recovery mode may have a jam frequency of about 2 jams per 200 cm³ of printing material, that is, 1 jam per 100 cm³, of printing material that cause the three-dimensional printer to require removal from service. Removal from service generally requires an inefficient troubleshooting procedure and manually clearing a jammed printing material from a component of the linear feed mechanism, the material pathway, or the print head itself. In contrast, three-dimensional printers having a jam clearing mode as described herein may reduce the jam frequency to less than 1 jam per 100 cm³ of printing material, such as 1 jam per 200 cm³of printing material, 1 jam per 400 cm³ spools of printing material, 1 jam per 600 cm³ of printing material, 1 jam per 800 cm³ spools of printing material, 1 jam per 1000 cm³ of printing material, or more.

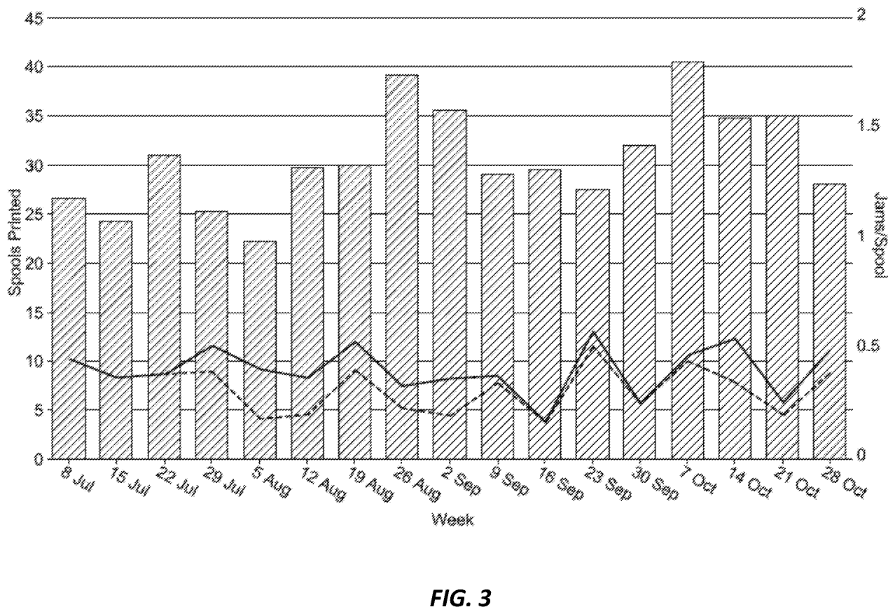

An example of the efficacy of the inclusion of a jam clearing mode for a three-dimensional printer described herein is illustrated in FIG. 3. With reference to FIG. 3, the bars indicate the number of spools of a printing material comprising 17-4 tool steel filament used on a particular calendar day (numbers indicated on the left Y-axis). The light-colored line across the bars is the number of unrecoverable jam events, i.e., jams requiring manual intervention, per spool without the jam clearing mode (numbers indicated on the right Y-axis) and the dark colored light-colored line across the bars is the number of unrecoverable jam events per spool with the jam clearing mode (numbers indicated on the right Y-axis). As illustrated in FIG. 3, without the jam clearing mode, approximately 0.5 jams per spool were unrecoverable without the jam clearing mode and approximately 0.35 jams per spool were unrecoverable using the jam clearing mode.

In some embodiments, the system includes a wiping station positioned in proximity to the print head. The controller may be configured to move the print head to the wiping station when a jam is detected; this is illustrated in FIG. 2, where wiping station 208 is shown in proximity to print head 202 with the double ended arrow near wiping station 208 indicating the travel of the print head 202. The wiping station may include a wiper that is configured to assist with clearing obstructions as described herein from the print head. The wiper of the wiping station may be any suitable material that is sufficiently abrasive to provide for cleaning and is suitably heat resistant but not damage the print head. For example, the wiper may comprise a metallic brush, such as brass or a similarly soft metal, that is less likely to damage the print head but can withstand the heat applied to the print head during the printing mode.

In some embodiments, the print head may be wiped on the wiper of the wiping station up to 10 passes, e.g., 1, 2, 3, 4, 5, 6, 7, 8, 9, or 10 passes, prior to operation of the jam clearing mode. Without wishing to be bound by any particular theory, the number of passes the print head is wiper on the wiper may be dependent, in part, on the printing material composition, i.e., the metal powder and/or printing material binder. One of skill in the art can appreciate that the number of passes needed on the wiper may be adjusted based on printing material properties.

In some embodiments, the print head may be wiped on the wiper of the wiping station for less than about 30 seconds, e.g., from about 1 second to about 10 seconds, about 5 seconds to about 15 seconds, about 10 seconds to about 20 seconds, about 15 seconds to about 25 seconds, or about 20 seconds to about 30 seconds, e.g., about 1 second, about 2 seconds, about 3 seconds, about 4 seconds, about 5 seconds, about 6 seconds, about 7 seconds, about 8 seconds, about 9 seconds, about 10 seconds, about 15 seconds, about 20 seconds, about 25 seconds, or about 30 seconds.

When configured as a metallic wire brush, the print head may be inserted into the bristles of the brush to a specific depth. In some embodiments, the print head may be placed at a depth of up to about 5 mm into bristles of the wire brush, e.g., about 0.5 mm, about 1 mm, about 1.5 mm, about 2 mm, about 2.5 mm, about 3 mm, about 3.5 mm, about 4 mm, about 4.5 mm, or about 5 mm.

In some embodiments, wiping of the print head may occur each time a jam is detected as described herein. Alternatively, or in addition, wiping of the print head may occur intermittently during operation of the printing mode without a jam as part of a preventative measure to reduce the frequency of jams. In some embodiments, wiping of the print head may occur during a printing material or material change, that is, when switching from one printing material to a different printing material, in order to reduce the likelihood of cross-contamination. In some embodiments, wiping of the print head may occur during the printing of parts that have particular geometries where the print head may tend to form a jam. In particular embodiments, wiping of the print head may occur prior to the start of a new print to reduce the likelihood of a jam occurring in the early phases of the start of a printing operation.

While the three-dimensional printer illustrated in FIG. 1 shows a printer having a single linear feed mechanism operatively coupled to a single print head, a three-dimensional printer may include any practical number of linear feed mechanisms operatively coupled to print heads. According to at least one embodiment, each print head of a three-dimensional printer may have its own wiping station. For example, in a two print head system, where one print head feeds a release material and the other feeds metal printing material, each print head will have a wiping station and each print head is configured to be wiped only on its associated wiping station to avoid contamination between materials.

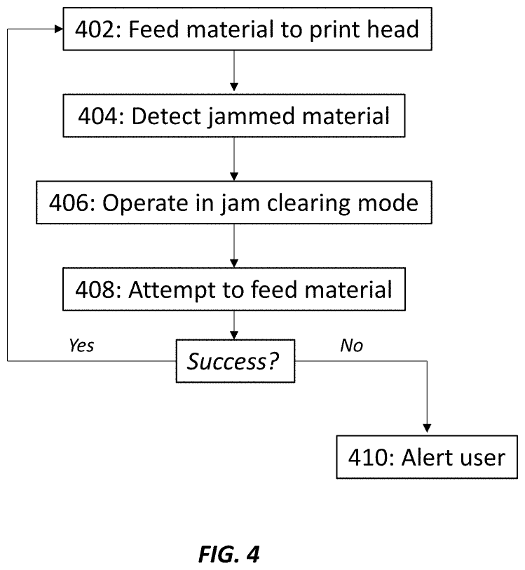

In accordance with one or more embodiments, there is provided a method of printing using a three-dimensional printer, with a schematic of an embodiment of a method of this disclosure illustrated in FIG. 4. With reference to FIG. 4, the method may comprise a step 402 of operating the three-dimensional printer 200 illustrated in FIG. 2 using a linear feed mechanism 206 to feed a printable material 201 to a print head 202 to deposit the printing material 201 in layers on a build platen 204, forming a part 203. The method may further comprise a step 404 of detecting that the printable material 201 is jammed in the three-dimensional printer 200. The method may additionally comprise a step 406 of operating the three-dimensional printer 200 in a jam clearing mode. The jam clearing mode may comprise advancing a drive component 206a of the linear feed mechanism 206, retracting the drive component 206a of the linear feed mechanism 206, and repeating the advancing and retracting of the drive component 206a of the linear feed mechanism 206, wherein one advancing step and one retracting step comprises one cycle of the jam clearing mode.

With continued references to FIGS. 2 and 4, the method of printing may include a step 408 of attempting to feed printable material 201 to the print head 202. In some embodiments, if the printable material 201 feeds successfully, the method of printing may include returning the three-dimensional printer 200 to the feeding printable material step 402. With continued reference to FIG. 4, the method of printing may include a step 410 of alerting an end user or operator if the jammed printable material cannot be cleared.

In some embodiments of the method of printing, the detecting of a jammed printing material may include detecting a force applied to the printing material by the drive component of the linear feed mechanism. For example, detecting the force applied to the printing material may include detecting a change in the motion of an idle component of the linear feed mechanism as described herein. In some embodiments of the method of printing, the advancing of the drive component of the linear feed mechanism may include advancing a drive wheel of the linear feed mechanism as described herein. In further embodiments, retracting of the drive component of the linear feed mechanism may include retracting the drive wheel of the linear feed mechanism as described herein. In some embodiments of the method of printing, the jam clearing mode may operate at a repetition rate of at least 1 Hz, with a cycle including one advance and one retract of the drive component as described herein. In some embodiments of the method of printing, the jam clearing mode may be operated for up to 256 cycles.

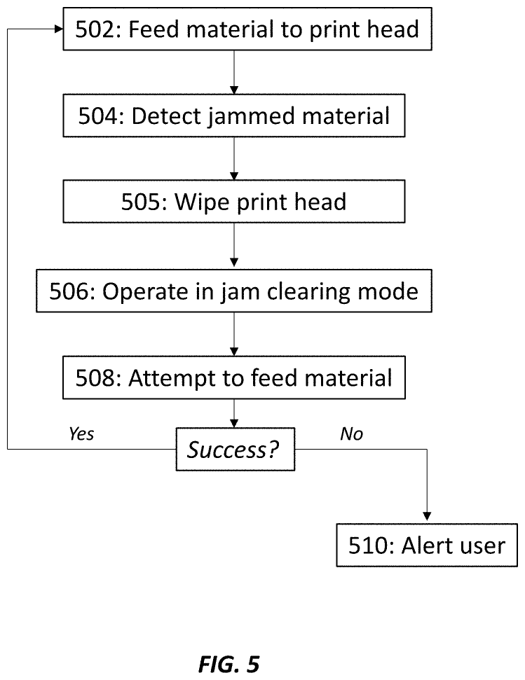

In some embodiments of the method of printing, the method may include wiping the print head, and a schematic of an embodiment of a method of this disclosure including wiping the print head is illustrated in FIG. 5. With reference to FIG. 5, the method may comprise a step 502 of operating the three-dimensional printer 200 illustrated in FIG. 2 using a linear feed mechanism 206 to feed a printable material 201 to a print head 202 to deposit the printing material 201 in layers on a build platen 204, forming a part 203. The method may further comprise a step 504 of detecting that the printable material 201 is jammed in the three-dimensional printer 200. The method may additionally comprise a step 505 of wiping the print head 202 on a wiping station 208 to break up and remove any obstructions at the tip of the print head 202. The method may further comprise a step 506 of operating the three-dimensional printer 200 in a jam clearing mode after wiping the print head 202 in the wiping station 208.

With continued reference to FIGS. 2 and 5, the method of printing may include a step 508 of attempting to feed printable material 201 to the print head 202. In some embodiments, if the printable material 201 feeds successfully, the method of printing may include returning the three-dimensional printer 200 to the feeding material step 502. With continued reference to FIG. 5, the method of printing may include a step 510 of alerting an end user or operator if the jammed printable material cannot be cleared. The wiping of the print head may occur in a wiping station as described herein.

In some embodiments of the method of printing, the method may include detecting an uncleared jammed printing material after the advancing and retracting of the drive component of the linear feed mechanism. As disclosed herein, if the jammed printing material cannot be cleared, an end user or operator may be alerted such that additional maintenance to the three-dimensional printer can be performed. For example, the jam clearing mode may operate for a predetermined number of advance-and-retract cycles and/or a predetermined period of time before the end user or operator is alerted.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

What is claimed is:

1. A method of printing using a three-dimensional printer, the method comprising:
feeding a printable material through a linear feed mechanism to a print head;
detecting that the printable material is jammed in the three-dimensional printer; and
operating, in response to detecting that the printable material is jammed, the three-dimensional printer in a jam clearing mode, the jam clearing mode comprising:
advancing a drive component of the linear feed mechanism,
retracting the drive component of the linear feed mechanism, and
repeating the advancing and retracting of the drive component of the linear feed mechanism, wherein one advancing step and one retracting step comprises one cycle of the jam clearing mode.

2. The method of claim 1, wherein detecting the jammed printable material includes detecting a force applied to the printable material by the drive component of the linear feed mechanism.

3. The method of claim 2, wherein detecting the force includes detecting a change in the motion of an idle component of the linear feed mechanism.

4. The method of claim 1, wherein the advancing of the drive component of the linear feed mechanism includes advancing a drive wheel of the linear feed mechanism.

5. The method of claim 4, wherein retracting of the drive component of the linear feed mechanism includes retracting the drive wheel of the linear feed mechanism.

6. The method of claim 1, wherein the jam clearing mode operates at a repetition rate of at least 1 Hz.

7. The method of claim 1, wherein the jam clearing mode is operated up to 256 cycles.

8. The method of claim 1, further comprising returning the three-dimensional printer to the printing mode upon clearing of the jammed printable material.

9. The method of claim 1, further comprising wiping the print head.

10. The method of claim 9, wherein wiping the print head occurs prior to the advancing of the drive component of the linear feed mechanism.

11. The method of claim 1, further comprising detecting an uncleared jammed printable material after the advancing and retracting of the drive component of the linear feed mechanism.

12. The method of claim 11, further comprising alerting a user or operator of the uncleared jammed printable material.

13. A three-dimensional printing system, the system comprising:
a print head;
a linear feed mechanism operatively coupled to the print head to advance a printing material into the print head; and
a controller operatively coupled to the three-dimensional printing system and configured to monitor a printing mode of the three-dimensional printing system, identify a jammed printing material in the three-dimensional printing system, and operate the three-dimensional printer in a jam clearing mode in response to identifying the jammed printing material, the jam clearing mode comprising:
advancing a drive component of the linear feed mechanism,
retracting the drive component of the linear feed mechanism, and
repeating the advancing and retracting of the drive component of the linear feed mechanism.

14. The system of claim 13, wherein the drive component comprises a drive wheel.

15. The system of claim 14, further comprising an idle component having an idler wheel configured to apply a horizontal force to compress the printing material against the drive wheel.

16. The system of claim 15, wherein the controller is further configured to identify the jammed printing material by sensing a force applied to the printing material by the drive wheel of the linear feed mechanism.

17. The system of claim 15, wherein in sensing the force, the controller is further configured to detect a change in the motion of the idler wheel of the linear feed mechanism of the three-dimensional printer.

18. The system of claim 16, wherein if the force applied to the printing material by the drive wheel exceeds a predetermined threshold, the controller is further configured to operate the three-dimensional printer in the jam clearing mode.

19. The system of claim 13, further comprising a wiping station comprising a wiper positioned in proximity to the print head.

20. The system of claim 19, wherein the wiper comprises a metallic brush.

21. The system of claim 19, wherein the controller is further configured to direct the print head to the wiping station before operating the three-dimensional printer in the jam clearing mode.

22. The system of claim 13, wherein the controller is further configured to detect a jammed printing material that has not been cleared after completion of the jam clearing mode.

23. The system of claim 22, wherein the controller is further configured to alert a user or operator of the jammed printing material that has not been cleared.
